(19) United States
(12) Patent Application Publication
(10) Pub. No.: US 2009/0075059 A1
(43) Pub. Date: Mar. 19, 2009

(54) ROOFING TILE WITH ENHANCED SURFACE DURABILITY AND PROCESSES FOR MANUFACTURING THE ROOFING TILE

(76) Inventors: Andreas DRECHSLER, Schaafheim (DE); Jurgen KLEIN, Rodgau-Jugesheim (DE); Florence YZIQUEL, Offenbach (DE); Jeffrey CHEN, Lyon (FR); Emmanuel FOURDRIN, Meyrie (FR)

Correspondence Address: NILS H. LJUNGMAN & ASSOCIATES, P. O. BOX 130, GREENSBURG, PA, 15601-0130, US

(21) Appl. No.: 12/197,603

(22) Filed: Aug. 25, 2008

Related U.S. Application Data
(63) Continuation-in-part of application No. PCT/IB2007/000934, filed on Feb. 13, 2007.

(30) Foreign Application Priority Data
Feb. 23, 2006 (EP) 06290304.2

(51) Int. Cl. B32B 13/00; B05D 3/10; B32B 5/16

(52) U.S. Cl. 428/323; 427/343; 427/299; 428/703

(57) ABSTRACT

A new roofing tile with enhanced surface durability and processes for manufacturing the same. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/IB2007/000934, filed on Feb. 13, 2007, which claims priority from European Patent Application No. 06290304.2, filed on Feb. 23, 2006. International Patent Application No. PCT/IB2007/000934 was pending as of the filing date of this application. The United States was an elected state in International Patent Application No. PCT/IB2007/000934.

### BACKGROUND

1. Technical Field

The present application relates to roofing tiles with enhanced surface durability and processes for making such roofing tiles.

2. Background Information

Background information is for informational purposes only and does not necessarily admit that subsequently mentioned information and publications are prior art.

In the following, the cement chemistry notation will be used: C═CaO; A═Al₂O₃; S═SiO₂; Ŝ═SO₃, H═H₂O.

Some methods for making roofing tiles utilize a hydraulic binder for forming a non-efflorescing cementitious body, comprising a source of calcium aluminate, a source of calcium silicate, a source of sulfate and a source of reactive silica, especially comprising 10-49 percent by weight of a source of active silica (based on the weight of the dry hydraulic binder), the balance comprising 40-90 percent by weight of the source of calcium aluminate selected from calcium sulfoaluminate cement or clinker, the source of calcium aluminate having at least 25 percent alumina or a C/A ratio of less than 3, 5-55 percent by weight of Portland cement or clinker as the source of calcium silicate, and 3-50 percent by weight of a source of sulphate, at least 25 percent of which is SO₃. These ingredients are in relative proportions to form, upon hydration, the products monosulfate (C₃A.Ŝ.12H), hydrated alumina (AH₃), as well as ettringite (C3A.3CŜ.32H) and strätlingite (C₂ASH₈). While trying to avoid efflorescence, the efficacy is based on the presence of sulfate and reactive silica to form said hydration products and to minimize the formation of portlandite (CH). The presence of a sulfate source and a reactive silica source is thus desired.

Some processes utilize a hydraulic cement forming compositions which comprise a high alumina cement blended with a latently hydraulic or pozzolanic material, especially blast furnace slag and silica fume, such that upon hydration, strätlingite is formed. This hydrate effectively blocks the conversion of calcium aluminate hydrates such as CAH₁₀ and C₂AH₈ to the denser C₃AH₆ phase, thus counteracting the normal strength loss of CAC binders during aging (a phenomenon in the art known as “conversion”). Here the technical problem is to maintain a high mechanical strength, which is not a critical property for the application intended in the present application.

There is however still a desire to provide a cementitious mixture that will provide a hard, durable surface, which has excellent acid erosion resistance and an ability to maintain a smooth surface during natural weathering. An additional objective is to provide a means of applying said cementitious mixture as a thin coating (0.5-2.0 millimeters) on various substrates like roofing tiles.

Generally, in the cement industry, certain terms are often used, including: hydration, setting, hardening, and curing. One general definition of hydration is the reaction of a cementitious mixture with water to form water-containing compounds. The setting and hardening of the cement are caused by the formation of these water-containing compounds. The setting of cement is generally defined in the industry as a stiffening process in which the cement becomes firm, although the cement can still be weak. The hardening of cement is generally defined in the industry as the process of strength growth, which may continue for weeks, months, or longer. Curing cement generally involves a process of maintaining satisfactory temperature and humidity conditions to allow hydration and hardening to take place.

### OBJECT OR OBJECTS

The present application provides a roofing tile comprising: (a) a substrate; and (b) a coating disposed on said substrate, the coating resulting from hydration and hardening of a mixture comprising a hydraulic binder, and the hydraulic binder comprising at least 60 percent by weight of a source of calcium aluminate and no more than 1 percent by weight of sulfate.

### SUMMARY

The present application relates to a novel roofing tile with enhanced surface durability, especially smoothness and acid-erosion resistance. The present application also provides processes for making the same. In one possible embodiment of the present application, the hydraulic binder of the roofing tile comprises less than 0.5 percent by weight of sulfate, and may be substantially free of sulfate.

In another possible embodiment, the hydraulic binder comprises at least 35 percent by weight of alumina.

In another possible embodiment, the source of calcium aluminate comprises a calcium aluminate cement having an alumina content higher than 35 percent, often higher than 45 percent.

In another possible embodiment, the hydraulic binder further comprises a pozzolanic material, having an alumina content of at least 20 percent by weight, often at least 30 percent.

In another possible embodiment, said hydraulic binder comprises at least 80 percent by weight of a source of calcium aluminate. In another embodiment, the hydraulic binder further comprises a fine limestone filler, often in an amount of 0-10 parts for 100 parts of calcium aluminate cement.

In another possible embodiment of the present application, the coating comprises additives such as retarders, accelerators, superplasticizers, rheological modifiers, defoamers, and thickeners, and a combination of a superplasticizer and retarder.

In another possible embodiment, said hydraulic binder comprises 20-50 parts of pozzolanic material for 100 parts of calcium aluminate cement.

In another possible embodiment, the hydration is obtained with a water to calcium aluminate source ratio of less than 0.4, often between 0.25 and 0.40.

In one possible embodiment, the tile material further comprises sand with a maximum diameter of less than 1 millimeter.

In another possible embodiment of the present application, tile material comprises at least 32.5 percent by weight of binder, often about 50 percent.

In another possible embodiment, the coating has a density of from 2.0 to 2.3 grams per cubic centimeters. In another embodiment, the substrate binder is based on Portland cement.

In another possible embodiment, the tile further comprises a coating on it.

Another possible embodiment of the present application also provides a process or method of manufacturing the roofing tile of the present application, comprising the steps of coating an exterior surface of a freshly made substrate with a paste and curing the article and the coating together.

The present application further in one possible embodiment provides a process for manufacturing a roofing tile, comprising the steps of: (i) providing a substrate; (ii) mixing water and a cementitious mixture comprising a hydraulic binder, the hydraulic binder comprising at least 60 percent by weight of a source of calcium aluminate and no more than 1.0 percent by weight of sulfate; (iii) and applying on the substrate a coating slurry of the mixture of step (ii); and (iv) causing hydration of the coating on the substrate of step (iii) into the roofing tile. This process is useful for the manufacture of the tiles of the present application.

Another possible embodiment of the present application further provides a process for manufacturing a roofing tile, comprising the steps of: (i) providing a substrate; (ii) mixing water and a cementitious mixture comprising a hydraulic binder, the hydraulic binder comprising at least 60 percent by weight of a source of calcium aluminate and no more than 1.0 percent by weight of sulfate; (iii) and applying on the substrate a coating slurry of the mixture of step (ii); and (iv) causing hydration, of the coating on the substrate of step (iii), into the roofing tile. This process is useful for the manufacture of the tiles of the present application.

In one possible embodiment, the coating slurry has a slump value between 135-175 millimeters, often 140-160 millimeters, for a period of at least 20 minutes, often at least 30 minutes.

In another possible embodiment, the air content of the slurry is less than 10 percent, and often closer to 5 percent.

In one possible embodiment of the present application, steps (ii) and (iii) are carried out as a co-extrusion. In another embodiment, step (iii) is carried out by a brush application.

In one possible embodiment, step (iii) is carried out by the bell process.

In another possible embodiment, the process further comprises a curing step at a relative humidity of from 70 percent to 100 percent and at a temperature of from 0 degrees Celsius to 60 degrees Celsius and for a period of from 30 minutes to 24 hours.

In another possible embodiment, the process further comprises a post-treatment acid wash. The present application is based on the use of a high alumina content hydraulic binder, with a very limited amount of sulfate and essentially no sulfate. The present application may thus provide a binder with a maximum alumina content, which would not have been possible in prior art formulations due to the diluting effect of added sulfate. A high alumina content in the binder is desirable for acid resistance due to the low solubility above pH 4 of hydrated alumina, the ultimate decomposition product of calcium aluminate hydrates in acidic or leaching environments. Moreover, the minimization of sulfate in the present application reduces the water demand in the system, thus allowing for higher densities and improved durability in the present application. Prior art compositions have correspondingly lower densities due to the high water demand of sulfoaluminate compounds such as monosulfate and ettringite. These compounds represent the principle phases formed in calcium aluminate systems comprising high additions of sulfate. Monosulfate and ettringite are substantially non-existent in the present application (i.e., they may, at most, represent a few percent, e.g. less than 5 percent).

### BRIEF DESCRIPTION OF THE DRAWINGS

The present application is explained in greater detail below with reference to the accompanying drawings:

FIG. 1 is a schematic representation of a process of one embodiment of the present application;

FIG. 2 is a schematic representation of the process of another embodiment of the present application;

FIG. 2A is a schematic representation of a brush application process of another embodiment of the present application; and

FIG. 3 is a Scanning Electron Microscopy (SEM) micrograph of a cross section of a tile, according to example 2, exposed for ten years to natural weathering.

### DESCRIPTION OF EMBODIMENT OR EMBODIMENTS

### Cementitious Material

One characteristic of at least one possible embodiment of the present application is the very low amount of source of sulfate or its substantial absence. The term “sulfate” or “source of sulfate” is intended to designate the reactive sulfate species, usually designated SO₄.

Components comprising low amounts of sulfate may thus be present, as long as their content is such that the upper limit for the sulfate content in the final composition is not exceeded.

Calcium aluminates are combinations of aluminum oxide, Al₂O₃, and calcium oxide, CaO. Calcium aluminate may be generated in situ by the use of separate sources of calcium oxide and alumina as ingredients, or, alternatively, alumina can be added afterwards to obtain the desired alumina concentration. The source of calcium aluminate cement is often a hydraulic binder such as Fondu (37% Al₂O₃), Secar 51 (50% Al₂O₃), and Secar 71 (68% Al₂O₃). The calcium aluminates may be crystallized in several different anhydrous phases such as (using cement notation) CA, C₃A and C₁₂A₇. The source of pozzolanic material can be ground blast furnace slag or fly ash.

In the present application the pozzolanic material, if present, represents less than 50 percent by weight of cement, often between 10 percent and 30 percent by weight. The pozzolanic material should often have a high Al₂O₃ content, at least above 20 percent, and often above 30 percent. The particle size distribution of fly ash can vary widely depending on the process. The D50 (mean particle size) of the fly ash can range can be between 2-60 micrometers as measured in the wet process on a Malvern laser granulometer. The amount of fly ash added may be limited by its granulometry. The preferred D50 granulometry of the fly ash is 10-20 micrometers.

A fine limestone filler may also be added to the slurry for improved compaction of the slurry or for reduced strength loss. The latter effect may arise from the formation of a carboaluminate phase, C₄AĈH₁₁. This phase tends to form at the expense of C₂AH₈ and C₃AH₆, thus hindering, but not necessarily permanently preventing, conversion (see H. F. W. Taylor, Cement Chemistry, second ed., Thomas Telford, London, 1997). The limestone filler, which may serve as a replacement or partial replacement of the pozzolanic material, can represent up to about 10 parts per 100 parts cement in the slurry. The fine limestone can have a D50 mean particle size of 1-10 micrometers, and often between 1-5 micrometers. It should be noted, however, that the intrinsic acid resistance of the slurry may decrease with increasing limestone content, due to the higher solubility of limestone relative to AH₃. The specific dosage of limestone filler will ultimately depend on the priorities placed on the rheological, strength, and durability properties of the slurry/coating. Sand of a fine grading, from 0.0-0.6 millimeters, is used to promote a smooth surface. This will also enhance the acid and freeze-thaw performance of the body. Durability can also be enhanced by optimizing the type and quantity of sand.

Additives effective with calcium aluminates based binders include defoamers, retarders typically citric acid, plasticizers, superplasticizers (e.g., polycarboxylate ether), pigments (e.g., inorganic or organic), rheology enhancers (e.g., acrylates emulsion), and thickeners (cellulose or wellan gum) may be added to achieve the desired fresh slurry properties.

A typical composition for a slurry would be the following (in parts by weight):

| Component | Parts | Preferred Parts^{a} |
|---|---|---|
| Fine sand, 0-0.6 millimeters | 50-200 | 130 |
| Calcium aluminate cement | 100 | 100 |
| Fly-ash (or other pozzolanic material) | <50 | 20 |
| Fine limestone filler | <10 | — |
| Pigment^{b} | <6 | 3 |
| Superplasticizer^{b} | <1.5 | 0.03 |
| Rheology modifier^{b} | <1.5 | 0.30 |
| Retarder^{b} | <0.3 | 0.10 |
| Defoamer^{c} | <0.3 | 0.15 |
| Thickener | <0.2 | — |
| Water | <40 | 36 |

^{a}Cited for a coextrusion process.
^{b}Expressed in terms of solids content.
^{c}Expressed in terms of active component.

As illustrated in one possible embodiment, a water to calcium aluminate source ratio lower than 0.4 can be used. This relatively low amount of water results in a dense final product.

### Process for Manufacturing

A general process for manufacturing the roofing tile comprises the following steps:

(i) preparing a concrete roofing tile substrate;

(ii) preparing a calcium aluminate cement rich slurry;

(iii) applying the slurry to the roofing tile substrate;

(iv) curing the coating and substrate together; and

(v) optionally post-treating the coating on the substrate, notably for aesthetic and/or durability reasons.

Some processes involve manufacturing stratified pieces such as roofing tiles by successive and independent extrusion of concrete, which is deposited on a limited part of the molds for the first layer. Thereafter follows a compacting and beveling step before the application of the second layer to completely fill the mold. Some processes involve a high pressure application of the top finish coating layer of a roofing tile onto the already pre-shaped and pre-compacted bottom layer.

The process of manufacturing the roofing tiles of the present application comprises first producing the concrete tile body or substrate by standard methods of mixing and extrusion of the tile body material using with a standard tile machine.

In one possible embodiment of the present application, the concrete tile substrates are made shortly before the application of the cementitious slurry to the tiles, so the substrates are sufficiently hard enough to be handled for the coating process. The setting process of the tile substrates may take 15-30 minutes.

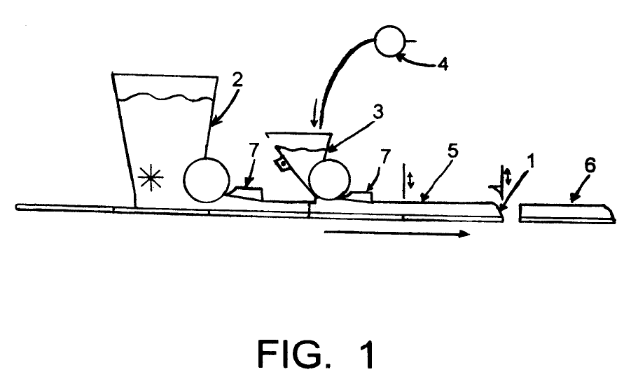

The second step of the process to manufacture the roofing tiles of the present application is to prepare the calcium aluminate-based slurry can be prepared in a batch process or in a continuously mixed process. One method is the batch mixed process where the wet and dry ingredients are placed in a mixer and agitated for 1-5 minutes, as is well known in the art of preparing cement slurry. The continuous mix method may be used in some industrial settings where the wet and dry ingredients can be pre-blended independently, and then combined in a high shear short mixer for a period of 5-20 seconds before the slurry is applied to the substrate. In a third process step, the tile is then coated with the slurry. The slurry is batched and prepared prior to mixing. The method of applying the slurry may vary, depending on the factory process, as well as the desired surface aesthetics (e.g., mono- versus multi-colored). Typical slurry application processes include coextrusion, brush application, and the so-called “bell” (or curtain coating) process. Each process often possesses distinctive rheological and formulation requirements. After the slurry is applied, the tile and coating are cured together under standard curing conditions (e.g., relative humidity of 70-100 percent, temperature 10 degrees Celsius to 60 degrees Celsius for a period of 30 minutes to 24 hours). One embodiment of the present application uses a coextrusion process, as illustrated in FIG. 1. The body of the tile is first extruded 1 using the tile body material 2. Then the slurry formulation 3, after mixing, is pumped via a pump 4 and extruded directly as a layer 5 onto the underlying fresh body. This inline process thus obviates the desire to transport the tile body to a separate slurry application unit. By this process it is possible to produce a flat or profiled roofing tile 6, which, with the action of the smoothing bars 7, possesses a smooth and homogeneous surface. The tile is then cured in conditions known within the industry. The double slipper method for coextrusion may be alternatively simulated by a double roller method, whereby the body and slurry are extruded sequentially, rather than essentially simultaneously.

In one possible embodiment of the present application, hydration begins when the slurry is prepared, and continues after the coating is applied to the tile body substrate. The curing process may aid hydration and allows for the setting and the hardening of the cementitious slurry. Setting and stiffening of the cement layer can be caused by early-stage hydrate formation and other formations during to hydration. Hardening, the continued strengthening of the cement, is formed and may continue for long periods of time.

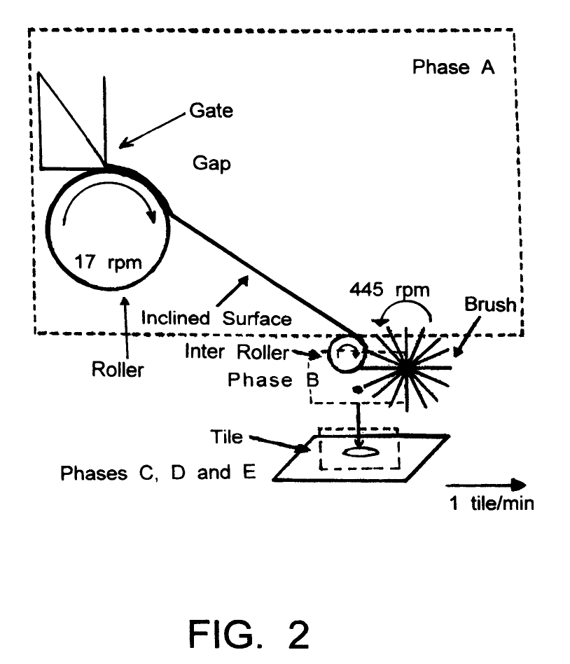

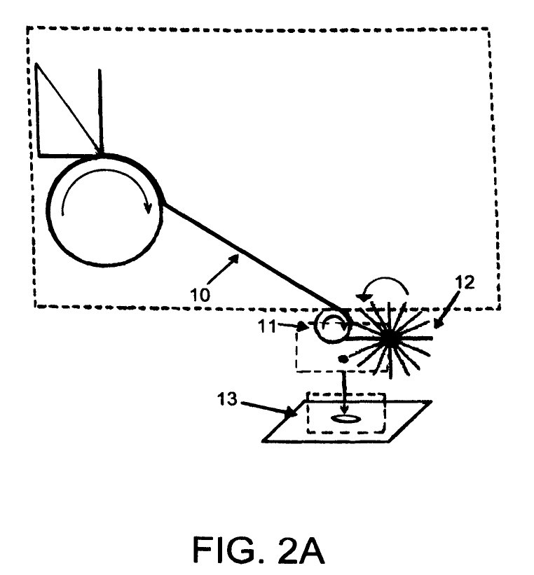

In another embodiment of the present application, the slurry is applied by a brush application, as illustrated in FIG. 2. This brush application process is accomplished in several phases, Phases A, B, C, D, and E. In this process, a relatively fluid slurry flows from its reservoir down a declined surface 10, and ultimately to the junction between the rotating inter-roller 11 and brush 12. The bristles of the brush 12 project the slurry as droplets onto the target tile 13. The size and speed of the droplets depend on the flow rate of the slurry as well as the rotation speeds of the rollers 11 and 15 and brush 12. In the possible embodiment of the brush application process represented by FIG. 2, the roller 15 is given a rotation speed of 17 revolutions per minute (rpm), and the brush 12 is given a rotation speed of 445 rpm. The embodiment in FIG. 2 also shows a possible production speed of 1 tile per minute. Multi-colored tile designs are possible from this process. The body and slurry coating are then cured under standard conditions. FIG. 2 also shows a gate 14 and a gap 16.

FIG. 2A shows another possible embodiment of a brush application process that can be used in the present application. A fluid cementitious slurry moves down a declined surface 10 to the junction between the rotating inter-roller 11 and the brush 12. The bristles of the brush 12 project the cementitious slurry as droplets onto the target tile 13. After the tile is coated with the slurry, it can then begin the curing process.

In yet another embodiment of the present application, the slurry is applied by the bell process, where a fluid slurry is passed over a bell-shaped piece, thereby creating a curtain through which the body substrate is passed. After the slurry is deposited on the body, the two are then cured together under standard conditions.

In another embodiment of the present application, the slurry is applied by a bell process. One conceivable embodiment of a bell process could possibly be found in the published German patent application DE 10057734 published May 23, 2002, having the following English translation of the German title “Web Curtain Coating Station, Especially Using a Pigment Suspension, Has a Guide in the Free Fall Path of the Coating to Divide the Path into Two Sections and Reduce Distorting Effects on the Laid Coating at the Moving Substrate Surface”, which is hereby incorporated by reference. FIGS. 8 and 9 show curved guides and a slurry material that is passed over the outside surfaces of these guides before forming a free-falling curtain. FIG. 8 of DE 10057734 shows a curved guide that is convex, and FIG. 9 of DE 10057734 shows a curved guide that is concave.

The purpose of incorporating the above patents, patent applications, and patent publications is solely for the purpose of providing additional information relating to features of one or more embodiments, which information may not be completely disclosed in the wording in the pages of this application. Words or equivalent words with the same meaning that relate to the opinions and judgments of the author or authors of any of the above cited patents, patent applications, and patent publications and not directly relating or relating to the technical details of the description of the embodiments in these cited publications are not incorporated by reference. The German words equivalent to the English words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, are not considered to be incorporated by reference except when these relate directly to technical details which are required to form a basis for adequate disclosure of the present application.

Another conceivable embodiment of a bell process could possibly be found in JP 8062774 published Mar. 8, 1996, with the following English translation of the Japanese title “Coating Method and Coating Device”, which is hereby incorporated by reference. FIG. 1 of JP 8062774 shows a slurry material being passed over a convex surface before forming a free-falling curtain.

The purpose of incorporating the above patents, patent applications, and patent publications is solely for the purpose of providing additional information relating to features of one or more embodiments, which information may not be completely disclosed in the wording in the pages of this application. Words or equivalent words with the same meaning that relate to the opinions and judgments of the author or authors of any of the above cited patents, patent applications, and patent publications and not directly relating or relating to the technical details of the description of the embodiments in these cited publications are not incorporated by reference. The Japanese words equivalent to the English words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, are not considered to be incorporated by reference except when these relate directly to technical details which are required to form a basis for adequate disclosure of the present application.

In another embodiment of the present application, the slurry is applied by a bell process, that is, a curtain coating process that utilizes a device shaped like a bell, or, in other words, a cup-shaped device having a flared mouth or flared opening. The bell-shaped device is oriented so that flared mouth or opening serves as the bottom. In another embodiment of the bell process, the device can be curved either to form a concave surface or a convex surface. To begin the bell process, the relatively fluid slurry flows over the outside surface of the bell-shaped or curved device. The slurry then flows over the outside of the flared portion of the device and free falls over a distance to form a continuous curtain or sheet of slurry. In one possible embodiment of the present application, the flow of slurry over the flared portion of the bell-shaped device may possibly create a curtain that is vertical or virtually vertical. In another embodiment of the present application, the curtain or sheet of slurry may possibly be arcuate, such as a portion of a circle. It may be theoretically possible for some reasons that a straight curtain, which may be perpendicular to the direction of movement of the roofing tile substrate to be coated with the slurry, may not be desirable. In such situations, it is theoretically possible to create a curtain that is not entirely straight or entirely perpendicular to the direction of movement of the substrate to be coated, and also theoretically possible to create a curtain which may be of a minimal curve, thereby possibly creating a curved curtain. The roofing tile substrate is then passed through the curtain of slurry to coat the upper surface of the substrate with the slurry. The roofing tile substrate may be passed through the curtain of slurry with the use of a conveyor, which moves the substrate at a controlled and constant speed to allow for an even coating of the slurry on the substrate. The speed of the substrate being passed through the curtain or sheet of slurry, as well as the amount of slurry being passed over the bell-shaped device, determines the thickness of the coating on the slurry. A gap in the conveyor, or a gap between two conveyors, lets unused slurry material fall through the gap and be collected. Any collected unused slurry material is then recycled and used to coat additional substrates.

In the above processes, the mortar for the tile body is often produced by first mixing the solids in a batch mixer (any batch mixer suffices), then introducing the liquids and mixing the slurry in 2 stages, with a moisture control test conducted in between. The overall moisture content of the tile body is adjusted to a sufficiently low value (typically 6.5-8.0 percent depending on the initial state of the raw materials) so as to give the desired rheology and to reduce undesirable bubbles in the overlying slurry. The tile bodies may be extruded using roller and smoothing bars as known in the art. The tile body weight may range from 3.0 to 6.0 kilograms for tile dimensions that are typically 4300 millimeters by 3300 millimeters.

As already indicated above, the slurry is mixed (e.g. using a high-shear mixer) for 2 to 5 minutes, depending on the type of mixer used. The rheology of the fresh mix can be assessed with a slump test. The equipment typically used for such a test is described in DIN 1048-T1 (slump table) and EN 196-3 (test sample receptacle). The process, adapted from various standards, involves first filling a cylindrical sample receptacle (8 centimeter diameter, 4 centimeter height) with the fresh slurry. The receptacle, which is placed in the center of the slump table, is then removed. A coextruded slurry should often show nearly zero initial slump under its own weight. After the slump table is lifted 15 times (15 knocks) to a fixed height, the slump of the slurry is measured; an average of 2 or virtually 2 perpendicular diameters is taken. Optimal coextrusion performance is obtained with slump values between 135-175 millimeters, often 140-160 millimeters. To promote relatively consistent large-scale production this slump should be maintained for a period of at least 20 minutes, often at least 30 minutes, depending on the manufacturing process. Furthermore, a good quality slurry has a smooth and creamy consistency and a lack of excessively large air bubbles. While there is no rigorous limit on the air content of the fresh slurry, it should be less than 10 percent, and often closer to 5 percent.

To reach the target fresh slurry properties mentioned above for the coextruded slurry, one will use the proper combination and type of additives, as appreciated by the skilled worker in the art. A combination of a superplasticizer based on polycarboxylate polyox molecules and an effective calcium aluminate retarder (e.g., citric acid) can provide excellent fluidity and workability for 1 hour or longer. Plasticizers based on naphthalene-type and especially melamine-type resins are not preferred since the workability may not be sufficient for practical use. Rheological modifiers are added to facilitate the pumpability of the slurry. Defoamers are used to reduce the overall air content as well as the large, obtrusive bubbles that have deleterious effects on the aesthetics and the durability of the surface.

After curing, the tile product may be further treated by acid washing for cleaning purposes, or by coating with paints, clear-coats, and other protective coatings.

### Roofing Tile

The resulting roofing tile of the present application comprises a relatively thin coating, or slurry, based on a calcium aluminate cement binder, in one possible embodiment with a thickness of 0.5-2 millimeters, and in another possible embodiment with a thickness of about 1 millimeter.

The high aluminate content of the slurry of the roofing tile of the present application encourages the formation of a dense layer of hydrated alumina (AH₃) gel. Depending on the curing conditions, this hydrate may form during the initial curing process. The formation of AH₃ can also be significantly accelerated upon exposure of the slurry to acidic solution. This acid exposure can be an intentional post-treatment, such as a brief acid wash of the slurry at pH values above 4, or often, the acid can be introduced naturally in the form of acid rain during natural weathering. Both routes will produce a dense AH₃ layer due to the infilling of surface pores by the AH₃ gel. The layer, whose thickness can be tens to hundreds of microns, thus serves as a protective barrier layer that is dense, hard, and subsequently resistant to erosion and other forms of degradation. The low solubility of AH₃ above pH 4 further increases the erosion resistance of the surface. Moreover, the formation of the AH₃ layer results in a smooth surface, which is useful in reducing the potential for colonization by microorganisms such as algae and lichens since they would not grow in the irregularities of the surface. The substrate, generally 6-20 millimeters in thickness, possesses coarser aggregates than the slurry, using standard sand 0-4 millimeters in diameter. Small amounts of inorganic standard pigments and of plasticizers may be added. The binder in the substrate is generally comprised of OPC (Ordinary Portland Cement) or OPC and pozzolanic material (with the ratio of OPC to pozzolanic material ranging from 100:0 to 70:30). A typical composition for the tile body is given below.

| Component | Kilogram |
|---|---|
| Sand, 0-4 mm | 1150 |
| Ordinary Portland Cement | 290 |
| Pigment^{a} | 8.0 |
| Superplasticizer^{a} | 0.0-0.5 |
| Water/Cement | 0.4 |

^{a}Expressed in terms of solids content.

### EXAMPLES

The following examples, which are based on the coextrusion process, are illustrative of the present application and shall not be considered limiting the scope thereof. The amounts are expressed in kilograms.

### Example 1

| Component | Example 1 |
|---|---|
| Fine sand, 0-0.6 mm | 130 kg |
| Calcium aluminate cement | 100 kg |
| Fly-ash | 20 kg |
| Pigment^{a} | 3.0 kg |
| Superplasticizer^{a} (Premiafluid 194) | 0.03 kg |
| Rheology enhancer^{a} (Mowilith VDM618) | 0.30 kg |
| Retarder^{a} (citric acid) | 0.10 kg |
| Defoamer^{b} (Serdas GBR) | 0.15 kg |
| Water | 36.0 kg |

Expressed in terms of solids content^{a} or active component^{b}.

Example 1 is produced from the coextusion process depicted in FIG. 1.

The slurry is mixed using a high-shear mixer for 2 to 5 minutes.

TABLE
Fresh slurry properties of Example 1.

| | |
|---|---|
| Slump at 0 min (mm) | 155 |
| After 45 min (mm) | 165 |
| After 75 min (mm) | 160 |
| Air content (%) | 4.8% |

The slurry is then pumped using an eccentric screw pump operating at standard conditions and is delivered by a pressure pipe to the dosing hopper. Again, for extrusion standard roller and smoothing bars of the prior art may be used at standard operating conditions.

### Example 2

| Component | Example 2 | |
|---|---|---|
| Fine sand, 0-0.6 mm | 130 | kg |
| Calcium aluminate cement | 100 | kg |
| Fly-ash | 20 | kg |
| Pigment^{a} | 3.0 | kg |
| Plasticizer^{a} (melamine-type) | 0.20 | kg |
| Rheology enhancer^{a} (Mowilith VDM618) | — | |
| Retarder^{a} (citric acid) | — | |
| Defoamer^{b} (Serdas GBR) | — | |
| Water | 38-40 | kg |

Expressed in terms of solids content^{a} or active component^{b}.

The tiles of example 2 have been produced using a similar process to that depicted in example 1.

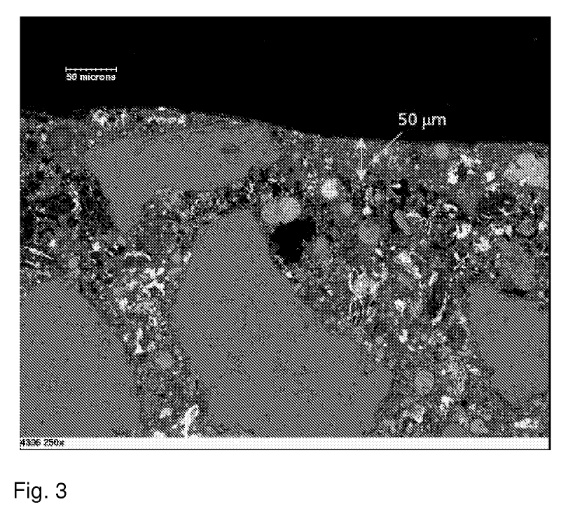

FIG. 3 is a Scanning Electron Microscopy (SEM) micrograph of a cross section of the tile from example 2, exposed for 10 years in natural weathering in a typical western European climate. SEM analysis was conducted in a back scattered electron (BSE) mode using 12 kilovolts, 1 nanoamp (measured with a Faraday cup) and a millimeter working distance.

As seen in FIG. 3, a dense, protective layer of AH₃ has formed spontaneously during natural weathering. This layer (here about 50 micrometers in thickness) serves as a protective and durable barrier, especially against erosion and roughening during weathering.

The following patents, patent applications or patent publications, and the patents, patent applications or patent publications found in the published international search report in WO 2007/096773, are hereby incorporated by reference as if set forth in their entirety herein: WO-A-0172658 entitled “NON-EFFLORESCING CEMENTITIOUS BODIES”; EP-A-0356086 entitled “CEMENT COMPOSITIONS”; U.S. Pat. No. 5,017,230 entitled “ASPHALT ADDITIVE COMPOSITIONS”; U.S. Pat. No. 4,986,744 entitled “APPARATUS FOR MANUFACTURING MULTI-LAYERED CONCRETE ROOF TILES”; U.S. Pat. No. 3,193,903 entitled “TILE CASTING INSTALLATION”; U.S. Pat. No. 4,666,648 entitled “METHOD AND APPARATUS FOR MANUFACTURING ROOF TILES”; US 2004/035328 entitled “NON-EFFLORESCING CEMENTITIOUS BODIES”; U.S. Pat. No. 4,366,209 entitled “SURFACE TREATING METHOD AND COMPOSITION FOR CEMENT”; U.S. Pat. No. 3,664,854 entitled “QUICK SETTING AND QUICK HARDENING CEMENT AND METHOD FOR PRODUCING THE SAME”; EP 1050518 entitled “SILICATE COMPOSITION”; US 2001/00771 entitled “MINERAL COATINGS FOR CONCRETE MOLDINGS”; WO 2005/037725 entitled “CEMENT ROOFING TILE CONSISTING OF AT LEAST TWO LAYERS”; EP 0970931 entitled “COMPOSITIONS USEFUL FOR SUPPRESSING EFFLORESCENCE ON MINERAL SUBSTRATES”; and publication “Role of a Small Addition of Acetic Acid on the Setting Behavior and on the Microstructure of a Calcium Aluminate Cement”, published in the Journal of the American Ceramic Society, vol. 88, no. 8, in August 2005.

The purpose of incorporating U.S. patents, Foreign patents, publications, etc. is solely to provide additional information relating to features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, are not considered to be incorporated by reference.

One feature or aspect of an embodiment is believed at the time of the filing of this patent application to possibly reside broadly in a roofing tile comprising: a substrate; and a coating disposed on said substrate, said coating resulting from hydration and hardening of a mixture comprising a hydraulic binder, said hydraulic binder comprising at least 60 percent by-weight of a source of calcium aluminate and no more than 1 percent by weight of sulfate.

Another feature or aspect of an embodiment is believed at the time of the filing of this patent application to possibly reside broadly in the roofing tile, wherein the hydraulic binder comprises less than 0.5 percent by weight of sulfate, and often is substantially free of sulfate.

Yet another feature or aspect of an embodiment is believed at the time of the filing of this patent application to possibly reside broadly in the roofing tile, wherein the hydraulic binder comprises at least 35 percent by weight of alumina.

Still another feature or aspect of an embodiment is believed at the time of the filing of this patent application to possibly reside broadly in the roofing tile, wherein the source of calcium aluminate comprises a calcium aluminate cement having an alumina content higher than 35 percent, often higher than 45 percent.

A further feature or aspect of an embodiment is believed at the time of the filing of this patent application to possibly reside broadly in the roofing tile, wherein the hydraulic binder further comprises a pozzolanic material, often having an alumina content of at least 20 percent by weight, often at least 30 percent.

Another feature or aspect of an embodiment is believed at the time of the filing of this patent application to possibly reside broadly in the roofing tile, wherein the hydraulic binder further comprises a fine limestone filler, often in an amount of 0-10 parts for 100 parts of calcium aluminate cement.

Yet another feature or aspect of an embodiment is believed at the time of the filing of this patent application to possibly reside broadly in the roofing tile, wherein said hydraulic binder comprising at least 80 percent by weight of a source of calcium aluminate.

Still another feature or aspect of an embodiment is believed at the time of the filing of this patent application to possibly reside broadly in the roofing tile, wherein said hydraulic binder comprises 20-50 parts of pozzolanic material for 100 parts of calcium aluminate cement.

A further feature or aspect of an embodiment is believed at the time of the filing of this patent application to possibly reside broadly in the roofing tile, wherein the hydration is obtained with a water to calcium aluminate source ratio of less than 0.4, often between 0.25 and 0.40.

Another feature or aspect of an embodiment is believed at the time of the filing of this patent application to possibly reside broadly in the roofing tile, wherein the coating comprises additives such as retarders, accelerators, superplasticizers, rheological modifiers, defoamers, and thickeners, and often a combination of a superplasticizer and retarder.

Yet another feature or aspect of an embodiment is believed at the time of the filing of this patent application to possibly reside broadly in the roofing tile, wherein the tile material further comprises sand with a maximum diameter of less than 1 millimeter.

Another feature or aspect of an embodiment is believed at the time of the filing of this patent application to possibly reside broadly in the roofing tile, wherein the tile material comprises at least 32.5 percent by weight of binder, and often about 50 percent.

Yet another feature or aspect of an embodiment is believed at the time of the filing of this patent application to possibly reside broadly in the roofing tile, wherein the coating has a density of from 2.0 to 2.3 grams per cubic centimeters.

Still another feature or aspect of an embodiment is believed at the time of the filing of this patent application to possibly reside broadly in the roofing tile, wherein the substrate binder is based on Portland cement.

A further feature or aspect of an embodiment is believed at the time of the filing of this patent application to possibly reside broadly in the roofing tile, wherein the mixture comprises the following components, in parts by weight:

| Component | Parts |
|---|---|
| Fine sand, 0-0.6 mm | 50-200 |
| Calcium aluminate cement | 100 |
| Fly-ash (or other pozzolan) | <50 |
| Fine limestone filler | <10 |
| Pigment^{a} | <6 |
| Superplasticizer^{a} | <1.5 |
| Rheology modifier^{a} | <1.5 |
| Retarder^{a} | <0.3 |
| Defoamer^{b} | <0.3 |
| Thickener | <0.2 |
| Water (total liquid) | <40 |

Expressed in terms of solids content^{a} or active component^{b}.

Another feature or aspect of an embodiment is believed at the time of the filing of this patent application to possibly reside broadly in the roofing tile, further comprising a coating on it.

Yet another feature or aspect of an embodiment is believed at the time of the filing of this patent application to possibly reside broadly in a process of manufacturing the roofing tile, comprising the steps of coating an exterior surface of a freshly made substrate with a paste and curing the article and the coating together.

Still another feature or aspect of an embodiment is believed at the time of the filing of this patent application to possibly reside broadly in a process for manufacturing a roofing tile, comprising the steps of: (i) providing a substrate; (ii) mixing water and a cementitious mixture comprising a hydraulic binder, said hydraulic binder comprising at least 60 percent by weight of a source of calcium aluminate and no more than 1.0 percent by weight of sulfate; (iii) applying on said substrate a coating slurry of the mixture of step (ii); and (iv) causing hydration of said coating on the substrate of step (iii) into the roofing tile.

Another feature or aspect of an embodiment is believed at the time of the filing of this patent application to possibly reside broadly in a process for manufacturing a roofing tile, comprising the steps of: (i) providing a substrate; (ii) mixing water and a cementitious mixture comprising a hydraulic binder, said hydraulic binder comprising at least 60 percent by weight of a source of calcium aluminate and no more than 1.0 percent by weight of sulfate; (iii) applying on said substrate a coating slurry of the mixture of step (ii); and (iv) causing hydration, of said coating on the substrate of step (iii), into the roofing tile.

A further feature or aspect of an embodiment is believed at the time of the filing of this patent application to possibly reside broadly in the process of manufacturing a roofing tile, wherein the roofing tile comprises a coating on it.

Another feature or aspect of an embodiment is believed at the time of the filing of this patent application to possibly reside broadly in the process wherein the coating slurry has a slump value between 135-175 mm, often 140-160 millimeters, for a period of at least 20 minutes, often at least 30 minutes.

Yet another feature or aspect of an embodiment is believed at the time of the filing of this patent application to possibly reside broadly in the process wherein the air content of the slurry is less than 10 percent, and often closer to 5 percent.

Another feature or aspect of an embodiment is believed at the time of the filing of this patent application to possibly reside broadly in the process wherein steps (ii) and (iii) are carried out as a co-extrusion.

Yet another feature or aspect of an embodiment is believed at the time of the filing of this patent application to possibly reside broadly in the process wherein step (iii) is carried out by a brush application.

Still another feature or aspect of an embodiment is believed at the time of the filing of this patent application to possibly reside broadly in the process wherein step (iii) is carried out by the bell process.

A further feature or aspect of an embodiment is believed at the time of the filing of this patent application to possibly reside broadly in the process which further comprises a curing step at a relative humidity of from 70 percent to 100 percent and at a temperature of from 0 degrees Celsius to 60 degrees Celsius and for a period of from 30 minutes to 24 hours.

Another feature or aspect of an embodiment is believed at the time of the filing of this patent application to possibly reside broadly in the process, further comprising a post-treatment acid wash.

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein.

The purpose of incorporating U.S. patents, Foreign patents, publications, etc. is solely to provide additional information relating to features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, are not considered to be incorporated by reference.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

The purpose of incorporating U.S. patents, Foreign patents, publications, etc. is solely to provide additional information relating to features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, are not considered to be incorporated by reference.

The corresponding foreign and international patent publication applications, namely, European Patent Application No. 06290304.2, filed on Feb. 23, 2006, having inventors Andreas DRECHSLER, Jürgen KLEIN, Florence YZIQUEL, Jeffrey CHEN, and Emmanuel FOURDRIN, and International Application No. PCT/IB2007/000934, filed on Feb. 13, 2007, having WIPO Publication No. WO2007/096773 and inventors Andreas DRECHSLER, Jürgen KLEIN, Florence YZIQUEL, Jeffrey CHEN, and Emmanuel FOURDRIN, are hereby incorporated by reference as if set forth in their entirety herein for the purpose of correcting and explaining any possible misinterpretations of the English translation thereof. In addition, the published equivalents of the above corresponding foreign and international patent publication applications, and other equivalents or corresponding applications, if any, in corresponding cases in Europe and elsewhere, and the references and documents cited in any of the documents cited herein, such as the patents, patent applications and publications, are hereby incorporated by reference as if set forth in their entirety herein.

The purpose of incorporating the Foreign equivalent patent application (PCT/IB2007/000934) and European Patent Application (06290304.2) is solely for the purpose of providing a basis of correction of any wording in the pages of the present application, which may have been mistranslated or misinterpreted by the translator. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, are not considered to be incorporated by reference.

Statements made in the original foreign patent applications No. PCT/IB2007/000934 and European Patent Application No. 06290304.2 from which this patent application claims priority which do not have to do with the correction of the translation in this patent application are not to be included in this patent application in the incorporation by reference.

The purpose of incorporating U.S. patents, Foreign patents, publications, etc. is solely to provide additional information relating to features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, are not considered to be incorporated by reference.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The purpose of incorporating U.S. patents, Foreign patents, publications, etc. is solely to provide additional information relating to features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, are not considered to be incorporated by reference.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

Some examples of manufacturing concrete tiles that may possibly be utilized or adapted for use in at least one possible embodiment may possibly be found in the following U.S. Pat. Nos.: 4,177,232 entitled “Coating Uncured Cementitious Surfaces”; 4,752,520 entitled “Reinforced Concrete Tile and Its Method of Manufacture”; 5,223,200 entitled “Method for Producing Concrete Roof Tiles”; and 5,406,766 entitled “Multi-Color Concrete Tiles and Method and Apparatus for Making Same”.

The purpose of incorporating the above patents, patent applications, and patent publications is solely for the purpose of providing additional information relating to features of one or more embodiments, which information may not be completely disclosed in the wording in the pages of this application. Words relating to the opinions and judgments of the author or authors of any of the above cited patents, patent applications, and patent publications and not directly relating or relating to the technical details of the description of the embodiments in these cited publications are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, are not considered to be incorporated by reference except when these relate directly to technical details which are required to form a basis for adequate disclosure of the present application.

Some examples of the curtain coating process that may possibly be utilized or adapted for use in at least one possible embodiment may possibly be found in the following U.S. patents: U.S. Pat. No. 5,813,183 entitled “Method of Coating”; WO 2008/076743 entitled “Curtain Coating Method Using Edge Guide Fluid”; U.S. Pat. No. 5,395,660 entitled “Edge Removal Apparatus for Curtain Coating”; and WO 2006/031538 entitled “Curtain Coating Method”.

The purpose of incorporating the above patents, patent applications, and patent publications is solely for the purpose of providing additional information relating to features of one or more embodiments, which information may not be completely disclosed in the wording in the pages of this application. Words relating to the opinions and judgments of the author or authors of any of the above cited patents, patent applications, and patent publications and not directly relating or relating to the technical details of the description of the embodiments in these cited publications are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, are not considered to be incorporated by reference except when these relate directly to technical details which are required to form a basis for adequate disclosure of the present application.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

What is claimed is:

1. A method of manufacturing a coated cement roofing tile; said coated cement roofing tile comprising: a cement roofing tile substrate with a coating disposed on said cement roofing tile substrate; said coating being configured to maximize surface durability during weathering, maximize surface smoothness during weathering, and maximize surface acid-erosion resistance during weathering;
said method comprising the steps of:
providing a cement roofing tile substrate;
mixing water and a cementitious mixture to form a cementitious slurry; said cementitious slurry comprising a hydraulic binder; said hydraulic binder comprising:
at least about sixty percent by weight of a material comprising calcium aluminate; and
no more than about one percent by weight of a sulfate;
applying said cementitious slurry to said cement roofing tile substrate and forming a cementitious coating on said cement roofing tile substrate;
hydrating said cementitious coating on said cement roofing tile substrate to form a coated cement roofing tile; and
hardening said cementitious coating to form an at least partially finished cement roofing tile.

2. The method according to claim 1, wherein said hardening comprises hydrating.

3. The method according to claim 2, wherein said cementitious slurry has a slump value of one of (A) and (B):
(A) between about one hundred thirty-five millimeters and about one hundred seventy-five millimeters, for a period of one of (C) and (D):
(C) at least about twenty minutes, and
(D) at least about thirty minutes; and
(B) between about one hundred forty millimeters and about one hundred sixty millimeters, for a period of one of (C) and (D):
(C) at least about twenty minutes, and
(D) at least about thirty minutes;
and wherein said cementitious slurry comprises an air content of one of (E) or (F):
(E) about less than ten percent, and
(F) about five percent.

4. The method according to claim 3, wherein said hardening comprises curing, said curing comprises:
curing at a relative humidity in the range of from about seventy percent to about one hundred percent;
maintaining a temperature in the range of from about zero degrees Celsius to about sixty degrees Celsius; and
curing for about thirty minutes to about twenty-four hours; and said method further comprises:
washing said at least partially finished roofing tile with an acid wash; and
applying an additional coating onto the surface of said cementitious coating.

5. The method according to claim 4, wherein said providing a roofing tile substrate and said applying said cementitious slurry comprise extruding said roofing tile substrate and extruding said cementitious slurry.

6. The method according to claim 4 including a roller and a brush, wherein said applying said cementitious slurry comprises:
rotating said roller and said brush substantially simultaneously;
moving said cementitious slurry between said roller and said brush by said rotating said roller and said brush; and
applying said cementitious slurry onto said roofing tile substrate with said roller and said brush.

7. The method according to claim 4 including a bell-shaped device, wherein said applying said cementitious slurry comprises:
passing said cementitious slurry over the outside of said bell-shaped device;
forming a curtain of said cementitious slurry by said passing said cementitious slurry over the outside of said bell-shaped device;
passing said roofing tile substrate through said curtain of said cementitious slurry; and
coating said roofing tile substrate with said cementitious slurry.

8. A method of manufacturing a roofing tile which comprises a roofing tile substrate with a cementitious coating disposed thereon,
said method comprising the steps of:
providing a roofing tile substrate;
mixing water and a cementitious mixture to form a cementitious slurry, which cementitious slurry comprises a hydraulic binder, which hydraulic binder comprises:
at least about sixty percent by weight of a material comprising calcium aluminate; and
no more than about one percent by weight of a sulfate;
applying said cementitious slurry to said roofing tile substrate and forming a cementitious coating on said roofing tile substrate;
at least partially solidifying said cementitious coating on said roofing tile substrate to form a coated roofing tile; and
hardening said at least partially solidified cementitious coating to form an at least partially finished roofing tile.

9. The method according to claim 8, wherein said at least partially solidifying comprises hydrating.

10. The method according to claim 9, wherein said hardening comprises hydrating.

11. The method according to claim 10, wherein said cementitious slurry has a slump value of one of (A) and (B):
(A) between about one hundred thirty-five millimeters and about one hundred seventy-five millimeters, for a period of one of (C) and (D):
(C) at least about twenty minutes, and
(D) at least about thirty minutes; and
(B) between about one hundred forty millimeters and about one hundred sixty millimeters, for a period of one of (C) and (D):
(C) at least about twenty minutes, and
(D) at least about thirty minutes.

12. The method according to claim 11, wherein said cementitious slurry comprises an air content of one of (E) or (F):
(E) about less than ten percent, and
(F) about five percent.

13. The method according to claim 12, wherein at least one of said at least partially solidifying and said hardening comprises curing, said curing comprises:
curing at a relative humidity in the range of from about seventy percent to about one hundred percent;
maintaining a temperature in the range of from about zero degrees Celsius to about sixty degrees Celsius; and
curing for about thirty minutes to about twenty-four hours.

14. The method according to claim 13, wherein said method further comprises washing said at least partially finished roofing tile with an acid wash.

15. The method according to claim 14, wherein said method further comprises applying an additional coating onto the surface of said cementitious coating.

16. The method according to claim 15, wherein said providing a roofing tile substrate and said applying said cementitious slurry comprise extruding said roofing tile substrate and extruding said cementitious slurry.

17. The method according to claim 15 including a roller and a brush, wherein said applying said cementitious slurry comprises:
rotating said roller and said brush substantially simultaneously;
moving said cementitious slurry between said roller and said brush by said rotating said roller and said brush; and
applying said cementitious slurry onto said roofing tile substrate with said roller and said brush.

18. The method according to claim 15 including a bell-shaped device, wherein said applying said cementitious slurry comprises:
passing said cementitious slurry over the outside of said bell-shaped device;
forming a curtain of said cementitious slurry by said passing said cementitious slurry over the outside of said bell-shaped device;
passing said roofing tile substrate through said curtain of said cementitious slurry; and
coating said roofing tile substrate with said cementitious slurry.

19. A roofing tile comprising:
(a) a substrate; and
(b) a coating disposed on said substrate, said coating resulting from hydration and hardening of a mixture comprising a hydraulic binder, said hydraulic binder comprising at least 60% by weight of a source of calcium aluminate and no more than 1% by weight of sulfate.

20. The roofing tile according to claim 19, said roofing tile further comprising one of (i), (ii), (iii), (iv), (v), (vi), (vii), (viii), (ix), (x), (xi), (xii), (xiii), (xiv), and (xv):
(i) wherein the hydraulic binder comprises less than 0.5% by weight of sulfate, and preferably is substantially free of sulfate;
(ii) wherein the hydraulic binder comprises less than 0.5% by weight of sulfate, and preferably is substantially free of sulfate; and
wherein the hydraulic binder comprises at least 35% by weight of alumina;
(iii) wherein the hydraulic binder comprises less than 0.5% by weight of sulfate, and preferably is substantially free of sulfate;
wherein the hydraulic binder comprises at least 35% by weight of alumina; and
wherein the source of calcium aluminate comprises a calcium aluminate cement having an alumina content higher than 35%, preferably higher than 45%;
(iv) wherein the hydraulic binder comprises less than 0.5% by weight of sulfate, and preferably is substantially free of sulfate;
wherein the hydraulic binder comprises at least 35% by weight of alumina;
wherein the source of calcium aluminate comprises a calcium aluminate cement having an alumina content higher than 35%, preferably higher than 45%; and
wherein the hydraulic binder further comprises a pozzolanic material, preferably having an alumina content of at least 20% by weight, preferably at least 30%;
(v) wherein the hydraulic binder comprises less than 0.5% by weight of sulfate, and preferably is substantially free of sulfate;
wherein the hydraulic binder comprises at least 35% by weight of alumina;
wherein the source of calcium aluminate comprises a calcium aluminate cement having an alumina content higher than 35%, preferably higher than 45%;
wherein the hydraulic binder further comprises a pozzolanic material, preferably having an alumina content of at least 20% by weight, preferably at least 30%; and
wherein the hydraulic binder further comprises a fine limestone filler, preferably in an amount of 0-10 parts for 100 parts of calcium aluminate cement;
(vi) wherein the hydraulic binder comprises less than 0.5% by weight of sulfate, and preferably is substantially free of sulfate;
wherein the hydraulic binder comprises at least 35% by weight of alumina;
wherein the source of calcium aluminate comprises a calcium aluminate cement having an alumina content higher than 35%, preferably higher than 45%;
wherein the hydraulic binder further comprises a pozzolanic material, preferably having an alumina content of at least 20% by weight, preferably at least 30%;
wherein the hydraulic binder further comprises a fine limestone filler, preferably in an amount of 0-10 parts for 100 parts of calcium aluminate cement; and
wherein said hydraulic binder comprising at least 80% by weight of a source of calcium aluminate;
(vii) wherein the hydraulic binder comprises less than 0.5% by weight of sulfate, and preferably is substantially free of sulfate;
wherein the hydraulic binder comprises at least 35% by weight of alumina;
wherein the source of calcium aluminate comprises a calcium aluminate cement having an alumina content higher than 35%, preferably higher than 45%;
wherein the hydraulic binder further comprises a pozzolanic material, preferably having an alumina content of at least 20% by weight, preferably at least 30%;
wherein the hydraulic binder further comprises a fine limestone filler, preferably in an amount of 0-10 parts for 100 parts of calcium aluminate cement;
wherein said hydraulic binder comprising at least 80% by weight of a source of calcium aluminate; and
wherein said hydraulic binder comprises 20-50 parts of pozzolanic material for 100 parts of calcium aluminate cement;
(viii) wherein the hydraulic binder comprises less than 0.5% by weight of sulfate, and preferably is substantially free of sulfate;
wherein the hydraulic binder comprises at least 35% by weight of alumina;
wherein the source of calcium aluminate comprises a calcium aluminate cement having an alumina content higher than 35%, preferably higher than 45%;
wherein the hydraulic binder further comprises a pozzolanic material, preferably having an alumina content of at least 20% by weight, preferably at least 30%;
wherein the hydraulic binder further comprises a fine limestone filler, preferably in an amount of 0-10 parts for 100 parts of calcium aluminate cement;
wherein said hydraulic binder comprising at least 80% by weight of a source of calcium aluminate;
wherein said hydraulic binder comprises 20-50 parts of pozzolanic material for 100 parts of calcium aluminate cement; and
wherein the hydration is obtained with a water to calcium aluminate source ratio of less than 0.4, preferably between 0.25 and 0.40;
(ix) wherein the hydraulic binder comprises less than 0.5% by weight of sulfate, and preferably is substantially free of sulfate;
wherein the hydraulic binder comprises at least 35% by weight of alumina;
wherein the source of calcium aluminate comprises a calcium aluminate cement having an alumina content higher than 35%, preferably higher than 45%;
wherein the hydraulic binder further comprises a pozzolanic material, preferably having an alumina content of at least 20% by weight, preferably at least 30%;
wherein the hydraulic binder further comprises a fine limestone filler, preferably in an amount of 0-10 parts for 100 parts of calcium aluminate cement;
wherein said hydraulic binder comprising at least 80% by weight of a source of calcium aluminate;
wherein said hydraulic binder comprises 20-50 parts of pozzolanic material for 100 parts of calcium aluminate cement;
wherein the hydration is obtained with a water to calcium aluminate source ratio of less than 0.4, preferably between 0.25 and 0.40; and
wherein the coating comprises additives such as retarders, accelerators, superplasticizers, rheological modifiers, defoamers, and thickeners, and preferably a combination of a superplasticizer and retarder;
(x) wherein the hydraulic binder comprises less than 0.5% by weight of sulfate, and preferably is substantially free of sulfate;
wherein the hydraulic binder comprises at least 35% by weight of alumina;
wherein the source of calcium aluminate comprises a calcium aluminate cement having an alumina content higher than 35%, preferably higher than 45%;
wherein the hydraulic binder further comprises a pozzolanic material, preferably having an alumina content of at least 20% by weight, preferably at least 30%;
wherein the hydraulic binder further comprises a fine limestone filler, preferably in an amount of 0-10 parts for 100 parts of calcium aluminate cement;
wherein said hydraulic binder comprising at least 80% by weight of a source of calcium aluminate;
wherein said hydraulic binder comprises 20-50 parts of pozzolanic material for 100 parts of calcium aluminate cement;
wherein the hydration is obtained with a water to calcium aluminate source ratio of less than 0.4, preferably between 0.25 and 0.40;
wherein the coating comprises additives such as retarders, accelerators, superplasticizers, rheological modifiers, defoamers, and thickeners, and preferably a combination of a superplasticizer and retarder; and
wherein the tile material further comprises sand with a maximum diameter of less than 1 millimeter;
(xi) wherein the hydraulic binder comprises less than 0.5% by weight of sulfate, and preferably is substantially free of sulfate;
wherein the hydraulic binder comprises at least 35% by weight of alumina;
wherein the source of calcium aluminate comprises a calcium aluminate cement having an alumina content higher than 35%, preferably higher than 45%;
wherein the hydraulic binder further comprises a pozzolanic material, preferably having an alumina content of at least 20% by weight, preferably at least 30%;
wherein the hydraulic binder further comprises a fine limestone filler, preferably in an amount of 0-10 parts for 100 parts of calcium aluminate cement;
wherein said hydraulic binder comprising at least 80% by weight of a source of calcium aluminate;
wherein said hydraulic binder comprises 20-50 parts of pozzolanic material for 100 parts of calcium aluminate cement;
wherein the hydration is obtained with a water to calcium aluminate source ratio of less than 0.4, preferably between 0.25 and 0.40;
wherein the coating comprises additives such as retarders, accelerators, superplasticizers, rheological modifiers, defoamers, and thickeners, and preferably a combination of a superplasticizer and retarder;
wherein the tile material further comprises sand with a maximum diameter of less than 1 millimeter; and
wherein the tile material comprises at least 32.5% by weight of binder, preferably about 50%;
(xii) wherein the hydraulic binder comprises less than 0.5% by weight of sulfate, and preferably is substantially free of sulfate;
wherein the hydraulic binder comprises at least 35% by weight of alumina;
wherein the source of calcium aluminate comprises a calcium aluminate cement having an alumina content higher than 35%, preferably higher than 45%;
wherein the hydraulic binder further comprises a pozzolanic material, preferably having an alumina content of at least 20% by weight, preferably at least 30%;
wherein the hydraulic binder further comprises a fine limestone filler, preferably in an amount of 0-10 parts for 100 parts of calcium aluminate cement;
wherein said hydraulic binder comprising at least 80% by weight of a source of calcium aluminate;
wherein said hydraulic binder comprises 20-50 parts of pozzolanic material for 100 parts of calcium aluminate cement;
wherein the hydration is obtained with a water to calcium aluminate source ratio of less than 0.4, preferably between 0.25 and 0.40;
wherein the coating comprises additives such as retarders, accelerators, superplasticizers, rheological modifiers, defoamers, and thickeners, and preferably a combination of a superplasticizer and retarder;
wherein the tile material further comprises sand with a maximum diameter of less than 1 millimeter;
wherein the tile material comprises at least 32.5% by weight of binder, preferably about 50%; and
wherein the coating has a density of from 2.0 to 2.3 grams/cubic centimeter;
(xiii) wherein the hydraulic binder comprises less than 0.5% by weight of sulfate, and preferably is substantially free of sulfate;
wherein the hydraulic binder comprises at least 35% by weight of alumina;
wherein the source of calcium aluminate comprises a calcium aluminate cement having an alumina content higher than 35%, preferably higher than 45%;
wherein the hydraulic binder further comprises a pozzolanic material, preferably having an alumina content of at least 20% by weight, preferably at least 30%;
wherein the hydraulic binder further comprises a fine limestone filler, preferably in an amount of 0-10 parts for 100 parts of calcium aluminate cement;
wherein said hydraulic binder comprising at least 80% by weight of a source of calcium aluminate;
wherein said hydraulic binder comprises 20-50 parts of pozzolanic material for 100 parts of calcium aluminate cement;
wherein the hydration is obtained with a water to calcium aluminate source ratio of less than 0.4, preferably between 0.25 and 0.40;
wherein the coating comprises additives such as retarders, accelerators, superplasticizers, rheological modifiers, defoamers, and thickeners, and preferably a combination of a superplasticizer and retarder;
wherein the tile material further comprises sand with a maximum diameter of less than 1 millimeter;
wherein the tile material comprises at least 32.5% by weight of binder, preferably about 50%;
wherein the coating has a density of from 2.0 to 2.3 grams/cubic centimeter; and
wherein the substrate binder is based on Portland cement;
(xiv) wherein the hydraulic binder comprises less than 0.5% by weight of sulfate, and preferably is substantially free of sulfate;
wherein the hydraulic binder comprises at least 35% by weight of alumina;
wherein the source of calcium aluminate comprises a calcium aluminate cement having an alumina content higher than 35%, preferably higher than 45%;
wherein the hydraulic binder further comprises a pozzolanic material, preferably having an alumina content of at least 20% by weight, preferably at least 30%;
wherein the hydraulic binder further comprises a fine limestone filler, preferably in an amount of 0-10 parts for 100 parts of calcium aluminate cement;
wherein said hydraulic binder comprising at least 80% by weight of a source of calcium aluminate;
wherein said hydraulic binder comprises 20-50 parts of pozzolanic material for 100 parts of calcium aluminate cement;
wherein the hydration is obtained with a water to calcium aluminate source ratio of less than 0.4, preferably between 0.25 and 0.40;
wherein the coating comprises additives such as retarders, accelerators, superplasticizers, rheological modifiers, defoamers, and thickeners, and preferably a combination of a superplasticizer and retarder;
wherein the tile material further comprises sand with a maximum diameter of less than 1 millimeter;
wherein the tile material comprises at least 32.5% by weight of binder, preferably about 50%;
wherein the coating has a density of from 2.0 to 2.3 grams/cubic centimeter;
wherein the substrate binder is based on Portland cement; and
wherein the mixture comprises the following components, in parts by weight:

| Component | Parts |
|---|---|
| Fine sand, 0-0.6 mm | 50-200 |
| Calcium aluminate cement | 100 |
| Fly-ash (or other pozzolan) | <50 |
| Fine limestone filler | <10 |
| Pigment^{a} | <6 |
| Superplasticizer^{a} | <1.5 |
| Rheology modifier^{a} | <1.5 |
| Retarder^{a} | <0.3 |
| Defoamer^{b} | <0.3 |
| Thickener | <0.2 |
| Water (total liquid) | <40 |

Expressed in terms of solids content^{a} or active component^{b};
and
(xv) wherein the hydraulic binder comprises less than 0.5% by weight of sulfate, and preferably is substantially free of sulfate;
wherein the hydraulic binder comprises at least 35% by weight of alumina;
wherein the source of calcium aluminate comprises a calcium aluminate cement having an alumina content higher than 35%, preferably higher than 45%;
wherein the hydraulic binder further comprises a pozzolanic material, preferably having an alumina content of at least 20% by weight, preferably at least 30%;
wherein the hydraulic binder further comprises a fine limestone filler, preferably in an amount of 0-10 parts for 100 parts of calcium aluminate cement;
wherein said hydraulic binder comprising at least 80% by weight of a source of calcium aluminate;
wherein said hydraulic binder comprises 20-50 parts of pozzolanic material for 100 parts of calcium aluminate cement;
wherein the hydration is obtained with a water to calcium aluminate source ratio of less than 0.4, preferably between 0.25 and 0.40;
wherein the coating comprises additives such as retarders, accelerators, superplasticizers, rheological modifiers, defoamers, and thickeners, and preferably a combination of a superplasticizer and retarder;
wherein the tile material further comprises sand with a maximum diameter of less than 1 millimeter;
wherein the tile material comprises at least 32.5% by weight of binder, preferably about 50%;
wherein the coating has a density of from 2.0 to 2.3 grams/cubic centimeter;
wherein the substrate binder is based on Portland cement;
wherein the mixture comprises the following components, in parts by weight:

| Component | Parts |
|---|---|
| Fine sand, 0-0.6 mm | 50-200 |
| Calcium aluminate cement | 100 |
| Fly-ash (or other pozzolan) | <50 |
| Fine limestone filler | <10 |
| Pigment^{a} | <6 |
| Superplasticizer^{a} | <1.5 |
| Rheology modifier^{a} | <1.5 |
| Retarder^{a} | <0.3 |
| Defoamer^{b} | <0.3 |
| Thickener | <0.2 |
| Water (total liquid) | <40 |

Expressed in terms of solids content^{a} or active component^{b};
and
wherein the roofing tile further comprises an additional coating on it.
